(19) United States
(12) Patent Application Publication
(10) Pub. No.: US 2017/0260427 A1
(43) Pub. Date: Sep. 14, 2017

(54) ELECTRICALLY CONDUCTIVE COMPOSITION

(71) Applicant: Heraeus Deutschland GmbH & Co. KG, Hanau (DE)

(72) Inventors: Tanja DICKEL, Neuberg (DE); Sebastian FRITZSCHE, Hanau (DE); Daniel HANSELMANN, Gelnhausen (DE); Katja STENGER, Wiesen (DE)

(21) Appl. No.: 15/507,102

(22) PCT Filed: Jun. 29, 2015
(86) PCT No.: PCT/EP2015/064740

§ 371 Date: Feb. 27, 2017

(30) Foreign Application Priority Data
Aug. 29, 2014 (EP) 14182791.5
Dec. 9, 2014 (EP) 14196871.9

(51) Int. Cl. C09J 9/02; C08K 3/08; C08K 3/04; C09J 163/00; H01B 1/22; H01B 1/12

(52) U.S. Cl. CPC C09J 9/02; H01B 1/22; H01B 1/124; C08K 3/042; C09J 163/00; C08K 3/08; C08K 2201/001; C08K 2201/005; C09J 2203/326; C09J 2205/102; C08K 2003/0806

(57) ABSTRACT

An electrically conductive composition containing:
(A) 2 to 35 vol.-% electrically conductive particles having an average particle size in the range of 1 to 25 μm and exhibiting an aspect ratio in the range of 5 to 30:1,
(B) 10 to 70 vol.-% non-metallic particles having an average particle size in the range of 1 to 25 μm, exhibiting an aspect ratio in the range of 1 to 3:1,
(C) 30 to 80 vol.-% of a curable resin system, and
(D) 0 to 10 vol.-% of at least one additive, in which the sum of the vol.-% of particles (A) and (B) totals 25 to 65 vol.-%.

### CROSS-REFERENCE TO RELATED APPLICATIONS

This application is a Section 371 of International Application No. PCT/EP2015/064740, filed Jun. 29, 2015, which was published in the English language on Mar. 3, 2016 under International Publication No. WO 2016/030051 A1, and the disclosure of which is incorporated herein by reference.

### BACKGROUND OF THE INVENTION

The present invention relates to an electrically conductive composition which can be used as an electrically conductive adhesive composition, in particular in electronics and microelectronics applications.

Electronic devices require electrically conductive connections to active and passive components.

Electrically conductive adhesives are used in a variety of applications to attach bare dies and other electronic components to a substrate, for example lead frames, printed circuit boards, flexible electronics, ceramic substrates (e.g., LTCC) or DCBs and the like. Such devices are used for example in communication (e.g., mobile phones, tablets and computers), power conversion (e.g., power electronic modules) or the like. There are numerous requirements for a conductive adhesive to meet for these applications. Besides high mechanical stability (adhesive power expressed as shear strength), high electrical and thermal conductivity and compatibility with a wide range of substrates are required.

An ideal CTE (coefficient of thermal expansion) of an electrically conductive adhesive is one representing a compromise between different CTEs of parts to be adhesively bonded to each other. Such a compromise CTE is a key factor for the stability of an adhesive bond.

Besides a fitting CTE, good thermal and electrical conductivity are also of notable importance in common applications.

There is a desire to provide an electrically conductive adhesive composition improved in CTE in terms of a best possible match of the CTEs of parts to be adhesively bonded to each other.

### BRIEF SUMMARY OF THE INVENTION

The invention relates to an electrically conductive composition comprising:
(A) 2 to 35 vol.-% (volume-%) electrically conductive particles having an average particle size in the range of 1 to 25 μm and exhibiting an aspect ratio in the range of 5 to 30:1,
(B) 10 to 70 vol.-% non-metallic particles having an average particle size in the range of 1 to 25 μm, exhibiting an aspect ratio in the range of 1 to 3:1,
(C) 30 to 80 vol.-% of a curable (hardenable, crosslinkable) resin system, and
(D) 0 to 10 vol.-% of at least one additive,
wherein the sum of the vol.-% of particles (A) and (B) totals 25 to 65 vol.-%. In an embodiment, the sum of the vol.-% of (A), (B), (C) and, if present, (D) may total 100 vol.-% of the electrically conductive composition.

### DETAILED DESCRIPTION OF THE INVENTION

The electrically conductive composition of the invention comprises 2 to 35 vol.-%, preferably 2 to 30 vol.-% and most preferably 2 to 20 vol.-% of electrically conductive particles (A) having an average particle size in the range of 1 to 25 μm, preferably 1 to 20 μm, most preferably 1 to 15 μm and exhibiting an aspect ratio in the range of 5 to 30:1, preferably 6 to 20:1, most preferably 7 to 15:1.

The vol.-% disclosed in the description and the claims refer to the electrically conductive composition of the invention, i.e., not yet cured, or, to be even more precise, to the electrically conductive composition prior to its use or application.

In the description and the claims, the term “average particle size” is used. It shall mean the average primary particle size (mean particle diameter, d₅₀) determined by laser diffraction. Laser diffraction measurements can be carried out making use of a particle size analyzer, for example, a Mastersizer 3000 from Malvern Instruments.

In the description and the claims, the term “aspect ratio” is used with regard to the shape of the particles (A) and (B) included in the electrically conductive composition of the invention. The aspect ratio means the ratio of the largest dimension to the smallest dimension of a particle and it is determined by SEM (scanning electron microscopy) and evaluating the electron microscopical images by measuring the dimensions of a statistically meaningful number of individual particles.

A first group of electrically conductive particles (A) includes particles of a metal (alloy). The term “particles of a metal (alloy)” used herein shall mean particles of pure metal (purity of ≧99 weight-%) and/or of metal alloy. The metal or metal alloy has an electrical conductivity of, for example, >10⁷ S/m. Examples of useful metal (alloy) particles include silver (alloy) particles, gold (alloy) particles, aluminum (alloy) particles and copper (alloy) particles.

A second group of electrically conductive particles (A) includes particles which are coated with a metal, in particular with a metal having an electrical conductivity >10⁷ S/m. Examples include metal coated metal particles, e.g., silver coated copper particles and metal coated glass particles, e.g., silver coated glass particles.

The particles (A) exhibit an aspect ratio in the range of 5 to 30:1, preferably 6 to 20:1, most preferably 7 to 15:1. This aspect ratio indicates that the particles (A) are, for example, acicular particles (needles) or flakes (platelets) as opposed to, for example, particles having a spherical, an essentially spherical, an elliptical or an ovoid shape.

The electrically conductive composition of the invention may comprise one type of particles (A) or a combination of two or more different types of particles (A). For example, the electrically conductive composition of the invention may comprise one type of metal (alloy) particles (A) or a combination of different types of metal (alloy) particles (A). In any case, all types of particles (A) contained in the electrically conductive composition of the invention meet the afore mentioned average particle size and aspect ratio conditions. To illustrate this, the following theoretical example may be envisaged: An electrically conductive composition of the invention may comprise two different types of silver particles as the only particles (A), namely X vol.-% of silver particles having a d50 value of x μm and an aspect ratio of y:1, and Y vol.-% of silver particles having a d50 value of v μm and an aspect ratio of w:1, with X+Y lying in the 2 to 35 vol.-% range, x and v independently lying in the 1 to 25 μm range and y and w independently lying in the 5 to 30:1 range.

Particles of type (A) are commercially available. Examples of such particles include NZS-610, SF-3, SF-3J from Ames Goldsmith; TSC-10F20A, TSC-10F20B, and TSC-10F20C from Chang Sung; Silver Flake #80 from Ferro; and RA-0101, AA-192N from Metalor.

In an embodiment, the electrically conductive composition of the invention may comprise a portion, for example, 10 to 30 vol.-% of metal particles other than those of type (A), in particular, metal particles having an aspect ratio in the range of, for example, 1 to <5:1 or 1 to 3:1. One commercially available example of such metal particles is FA-3162 from Metalor.

The electrically conductive composition of the invention comprises 10 to 70 vol.-%, preferably 10 to 63 vol.-% and most preferably 15 to 60 vol.-% of non-metallic particles (B) having an average particle size in the range of 1 to 25 μm, preferably 1 to 20 μm, most preferably 1 to 15 μm and exhibiting an aspect ratio in the range of 1 to 3:1, preferably 1 to 2:1, most preferably 1 to 1.5:1. Examples of useful particles of the (B) type include graphite particles and electrically non-conductive non-metallic particles, in each case meeting these average particle size and aspect ratio conditions. The term “electrically non-conductive non-metallic particles” used herein shall mean non-metallic particles of a material having an electrical conductivity of <10⁻⁵ S/m. Examples of such materials include glass, ceramics, plastics, diamond, boron nitride, silicon dioxide, silicon nitride, silicon carbide, aluminosilicate, aluminum oxide, aluminum nitride, zirconium oxide and titanium dioxide.

The non-metallic particles (B) exhibit an aspect ratio in the range of 1 to 3:1, preferably 1 to 2:1, most preferably 1 to 1.5:1. This aspect ratio indicates that the particles (B) have a true spherical or essentially spherical shape as opposed to particles such as, for example, acicular particles or flakes. The individual particles (B) when looked at under an electron microscope have a ball like or near-to-ball like shape, i.e., they may be perfectly round or almost round, elliptical or they may have an ovoid shape.

The electrically conductive composition of the invention may comprise one type of particles (B) or a combination of two or more different types of particles (B). In any case, all types of particles (B) contained in the electrically conductive composition of the invention meet the afore mentioned average particle size and aspect ratio conditions.

Particles of type (B) are commercially available. Examples include AE9104 from Admatechs; EDM99,5 from AMG Mining; CL4400 and CL3000SG from Almatis; Glass Spheres from Sigma Aldrich; and Spheromers® CA6, CA10, and CA15 from Microbeads®.

In a preferred embodiment, the particles (A) have an average particle size in the range of 0.2 to 2 times the average particle size of the non-metallic particles (B).

The sum of the vol.-% of particles (A) and (B) totals 25 to 65 vol.-%.

The electrically conductive composition of the invention comprises 30 to 80 vol.-%, preferably 30 to 75 vol.-% and most preferably 30 to 70 vol.-% of a curable resin system (C).

The curable resin system (C) comprises those constituents of the electrically conductive composition of the invention which after the application and curing thereof form a covalently crosslinked polymer matrix in which the (A) and (B) particles are embedded.

Curable resin system means a resin system comprising at least one self-crosslinkable resin, typically, in combination with a starter or initiator, and/or one or more crosslinkable resins in combination with one or more hardeners (crosslinkers, curing agents) for the one or more crosslinkable resins. However, the presence of non-reactive resins within such curable resin system is also possible. To avoid misunderstandings, the term “resin system,” although generally understood to refer to polymeric materials, shall not be understood to exclude the optional presence of oligomeric materials. Oligomeric materials may include reactive thinners (reactive diluents). The border between oligomeric and polymeric materials is defined by the weight average molar mass determined by gel permeation chromatography (GPC; divinylbenzene-crosslinked polystyrene as the immobile phase, tetrahydrofuran as the liquid phase, polystyrene standards). Oligomeric materials have a weight average molar mass of <500, while the weight average molar mass of polymeric materials is >500.

Typically, the constituents of the curable resin system (C) are non-volatile; however, volatile compounds which can be involved in the curing mechanism of the curable resin system may also be present.

The curable resin system (C) is curable by the formation of covalent bonds. Covalent bond forming curing reactions may be free-radical polymerization, condensation and/or addition reactions, wherein condensation reactions are less preferred.

As has already been mentioned, the curable resin system (C) comprises those constituents of the electrically conductive composition of the invention which, after the application and curing thereof, form a covalently crosslinked polymer matrix or polymer network. This polymer matrix may be of any type, i.e., it may comprise one or more polymers or one or more hybrids of two or more different polymers. Examples of possible polymers may include (meth)acryl copolymers, polyesters, polyurethanes, polysiloxanes, polyethers, epoxy-amine-polyadducts and any combinations. The polymers forming this polymer matrix may stem from polymeric components of the curable resin system (C) and/or can be formed during polymer forming curing reactions of the curable resin system (C) after application and during curing of the electrically conductive composition of the invention.

Hence, the one or more resins which may be constituents of the curable resin system (C) may be selected from, for example, (meth)acryl copolymer resins, polyester resins, polyurethane resins, polysiloxane resins, polyether resins including epoxy resin type polyether resins, epoxy-amine-polyadducts and hybrids thereof.

Self-crosslinkable resins of the curable resin system (C) may be resins carrying functional groups capable of reacting among themselves under formation of covalent bonds in the sense of crosslinked network formation. In the alternative, self-crosslinkable resins are resins carrying different functional groups (F1) and (F2) in one and the same molecule, wherein the functional groups (F2) exhibit a reactive functionality complementary to the functionality of the functional groups (F1). The combination of a crosslinkable resin with a hardener means that the crosslinkable resin carries functional groups (F1), while the hardener carries other functional groups (F2) exhibiting a reactive functionality complementary to the functionality of the functional groups (F1). Examples of such complementary functionalities (F1)/(F2) are: carboxyl/epoxy, hydroxyl/isocyanate, epoxy/amine, free-radically polymerizable olefinic double bond/free-radically polymerizable olefinic double bond and the like. The reaction of the complementary functionalities (F1)/(F2) leads in any case to the formation of covalent bonds with the result of formation of a covalently crosslinked polymer network.

In a preferred embodiment, the curable resin system (C) comprises a self-crosslinkable epoxy resin or a system of epoxy resin and hardener for the epoxy resin selected among polyamine hardeners, polycarboxylic acid hardeners and polycarboxylic acid anhydride hardeners. The system of epoxy resin and polyamine hardener for the epoxy resin may optionally comprise lactone.

A curable resin system (C) comprising a self-crosslinkable epoxy resin may comprise a starter or an initiator. It may be a cationic curable system. To initiate cationic cure, it requires a cationic initiator, which may be thermo- or UV-labile. Hence, a cationically curable resin system (C) comprising a self-crosslinkable epoxy resin may be a thermally curable or a UV-curable resin system.

Examples of useful epoxy resins are bisphenol A and/or bisphenol F epoxy resins, novolac epoxy resins, aliphatic epoxy resins and cycloaliphatic epoxy resins. Examples of such commercially available epoxy resins include Araldite® GY 279, Araldite® GY 891, Araldite® PY 302-2, Araldite® PY 3483, Araldite® GY 281 and Quatrex® 1010 from Huntsman; D.E.R.™ 331, D.E.R.™ 732, D.E.R.™ 354 and D.E.N™ 431 from Dow Chemical; JER YX8000 from Mitsubishi Chemical; and EPONEX™ Resin 1510 from Momentive Specialty Chemicals.

Examples of useful polyamine hardeners for compounds are those comprising more than one primary or secondary amino group per molecule. Typical examples are diamines, triamines, and other polyamines with at least two amino groups in the molecule, wherein the amino groups are selected among primary and secondary amino groups. Secondary amino groups can be present as lateral or terminal functional groups or as member of a heterocyclic ring. Examples of preferred polyamine hardeners include diethylenetriamine, ethylenediamine, triethylenetetramine, aminoethylpiperazine and Jeffamine® D230 from Huntsman.

Examples of useful polycarboxylic acid hardeners include methylhexahydrophthalic acid and their possible anhydrides.

Examples of useful lactones are delta-valerolactone, delta-hexalactone, delta-nonalactone, delta-decalactone, delta-undecalactone, gamma-butyrolactone, gamma-hexalactone, gamma-heptalactone, gamma-octalactone, epsilon-caprolactone, epsilon-octalactone, epsilon-nonalactone and mixtures thereof.

The electrically conductive composition of the invention comprises 0 to 10 vol.-% of at least one additive (D).

Examples of additives include 4-cyclohexanedimethanol divinylether, organic solvents, for example, isopropanol, terpineol, wetting agents, for example, oleic acid, rheological modifiers, for example, nanosized silica, ethylcellulose.

The sum of the vol.-% of (A), (B), (C) and, if present, (D) may total 100 vol.-% of the electrically conductive composition.

In a preferred embodiment, the electrically conductive composition comprises or consists of:
(A) 2 to 35 vol.-% of the electrically conductive particles having an average particle size in the range of 1 to 25 μm and exhibiting an aspect ratio in the range of 5 to 30:1,
(B) 10 to 63 vol.-% of the non-metallic particles having an average particle size in the range of 1 to 25 μm, exhibiting an aspect ratio in the range of 1 to 3:1,
(C) 30 to 80 vol.-% of the curable resin system, and
(D) 0 to 10 vol.-% of the at least one additive,
wherein the sum of the vol.-% of particles (A) and (B) totals 25 to 65 vol.-%.

In another preferred embodiment, the electrically conductive composition comprises or consists of:
(A) 2 to 35 vol.-% of the electrically conductive particles having an average particle size in the range of 1 to 25 μm and exhibiting an aspect ratio in the range of 5 to 30:1,
(B) 15 to 60 vol.-% of the non-metallic particles having an average particle size in the range of 1 to 25 μm, exhibiting an aspect ratio in the range of 1 to 3:1,
(C) 30 to 80 vol.-% of the curable resin system, and
(D) 0 to 10 vol.-% of the at least one additive,
wherein the sum of the vol.-% of particles (A) and (B) totals 25 to 65 vol.-%.

Thus far, the composition of the electrically conductive composition of the invention has been looked at vol.-%-wise. In an embodiment, the electrically conductive composition of the invention comprises 15 to 60 wt.-% (weight-%) of the electrically conductive particles (A), 10 to 75 wt.-% of the particles (B), 7 to 35 wt.-% of the curable resin system (C), and (D) 0 to 5 wt.-% of the at least one additive, wherein the sum of the wt.-% of particles (A) and (B) totals 60 to 93 wt.-% and wherein the sum of the wt.-% of (A), (B), (C) and, if present, (D) may total 100 wt.-% of the electrically conductive composition. The wt.-% disclosed in the description and the claims refer to the electrically conductive composition of the invention, i.e., not yet cured, or to be even more precise, to the electrically conductive composition prior to its use or application.

Preferably, the viscosity of the electrically conductive composition of the invention is in the range of 4 to 45 mPa·s, most preferably 8 to 35 mPa·s, measured in accordance with DIN 53018 (at 23 ° C., CSR-measurement, cone-plate system, shear rate of 50 rounds per second).

The electrically conductive composition of the invention can be made by mixing components (A), (B), (C) and (D), wherein it is preferred to introduce component (C) first before adding components (A) and (B). After completion of the mixing, the so-produced electrically conductive composition of the invention can be stored until its use or application. It may be advantageous to store the electrically conductive composition of the invention at low temperatures of, for example, −78 to +8° C.

Depending on the chemical nature of the (C) component and, if desired or expedient, it is also possible to split component (C) into sub-components, for example, into a curable resin sub-component (C1) and a hardener sub-component (C2) and to mix (A), (B), (C1) and (D) and store that mixture separately from (C2). In so doing, a two-component type of electrically conductive composition of the invention is obtained. Its two components are stored separately from each other until use or application of the electrically conductive composition of the invention. The two components are then mixed shortly or immediately before the application.

The electrically conductive composition of the invention can be used as an electrically conductive adhesive composition, in particular in electronics and microelectronics applications. To this end, the electrically conductive composition of the invention is applied to the contact surface of a part to be adhesively bonded to another. Examples of such parts are diodes, LEDs (light emitting diodes), MIDs (molded interconnect devices), dies, IGBTs (insulated gate bipolar transistors, ICs (integrated circuits), sensors, connecting elements (e.g., clips), heat sinks, resistors, capacitors, inductors, antennae on the one hand and, on the other hand, substrates like DCB (direct copper bonded), IMS (insulated metal substrate), ceramics, plastics, composite materials like FR-4 glass epoxy, silicon, and metals in general. Application of the electrically conductive composition of the invention may be performed, for example, by printing, e.g., screen printing or stencil printing, by jetting or by dispensing. The typical thickness of the applied and uncured electrically conductive composition of the invention lies in the range of, for example, 5 to 50 μm.

After the application, a drying step may be performed in order to remove eventually present volatile compounds such as, for example, organic solvent. If such a drying step is performed, the drying parameters are, for example, 1 to 120 minutes at an object temperature of, for example, 60 to 160° C.

After the application and the optional drying, the other part to be adhesively bonded is put with its contact surface onto the layer of electrically conductive adhesive. The so formed assembly consisting of these parts with the layer of the electrically conductive composition in between is then cured. Curing may be initiated by UV irradiation if at least one of the parts to be adhesively bonded is transparent for UV light and if the curing chemistry of the (C) system allows for an UV curing. Examples of UV-curable (C) systems are the already mentioned curable resin system (C) comprising a self-crosslinkable epoxy resin and a UV-labile cationic initiator or a curable resin system (C) comprising free-radically polymerizable components and a UV-labile free-radical initiator. In the more common alternative of thermal curing, heat is applied and the electrically conductive composition or the assembly is heated, for example, for 5 to 30 minutes at an object temperature of, for example, 80 to 160° C.

In the hardened state, the electrically conductive composition of the invention is solid with a specific weight in the range of, for example 1.5 to 4 g/cm³. The specific weight of the cured electrically conductive composition of the invention is, for example, 12 to 30% less than that of a comparable electrically conductive composition not comprising the (A)/(B) particles in combination but instead metal particles only.

In the range of −50 to 200° C., the hardened electrically conductive composition of the invention exhibits CTE values in the range of, for example, 40 to 200 ppm/K. CTE values can be measured by dilatometric determination as is known to the person skilled in the art.

At 25° C., the hardened electrically conductive composition of the invention exhibits a sheet resistivity of, for example, >0 to ≦5 mΩ·cm.

The shear strength of the hardened electrically conductive composition of the invention, measured at 20° C. according to DIN EN 1465 lies, for example, in the range of >7.5 to 20 MPa. Customer requirements are met if the shear strength lies above 7 MPa.

A further embodiment of the invention is a hardened composition obtainable by hardening the hardenable electrically conductive composition of the present invention. Therefore, also an assembly, wherein the electrically conductive composition of the present invention is in a hardened state is part of the invention. In other words, a further embodiment of the invention is an assembly comprising a substrate, the hardened electrically conductive composition of the invention and an electronic component. The hardened electrically conductive composition of the invention serves as an electrically conductive adhesive and is therefore located between the substrate and the electronic component.

A further embodiment of the invention is the use of the electrically conductive composition of the invention as a hardenable electrically conductive adhesive, in particular in electronics and microelectronics applications.

The invention does not only satisfy the demand for CTE match but at the same time helps to save weight and money. While these weight savings are in particular relevant in an aviation and aerospace context and also generally in a transportation context, the financial savings result from fewer noble metal particles in the electrically conductive composition of the invention compared to conventional electrically conductive adhesive compositions containing noble metal particles. It goes without saying that the electrically conductive composition of the invention shows these advantages without sacrificing fundamental properties like shear strength and electrical and thermal conductivity.

The embodiments and advantages of the invention are further explained by the following non-limiting examples.

### EXAMPLES

### 1. Test Methods

1.1. Sheet Resistivity (mOhm·cm)

The electrical resistivity was measured at 25° C. according to the four point probe measurement (F. M. Smits, “Measurement of Sheet Resistivities with the Four-Point Probe”, published in THE BELL SYSTEM TECHNICAL JOURNAL, MAY 1958, pages 711-718, or the web-site: “http://en.wikipedia.org/wiki/Sheet_resistance”)

### 1.2. Density

The density of the uncured electrically conductive composition was measured at 25° C. using a pycnometer.

### 1.3. Shear Strength

The shear strength was measured according to DIN EN 1465.

### 2. Preparation and Application of Electrically Conductive Compositions, General Procedure:

A mixture of components of type (C) and (D) was made by mixing 63 pbw (parts by weight) of Araldite® PY 302-2 (epoxy resin) from Huntsman, 8 pbw of Curezol® C2E4MZ (hardener) from Shikoku, 23 pbw Araldite® DY-E (reactive diluent) from Huntsman, 4 pbw of 4-cyclohexanedimethanol divinylether and 2 pbw of oleic acid.

The compositions E1-E5 were prepared by mixing the components according to Table 1 below. Mixing was performed by introducing the mixture of components (C) and (D) into a beaker and then mixing with the further components with a spatula, followed by mixing with a paddle mixer at 300 to 400 U/min for 5 min. Thereafter, the mixtures were milled twice in a triple roll mill at 21° C., followed by evacuation at less than 10 mbar under stirring with a paddle mixer for 20 min. The so produced mixtures were screen printed in 100 μm layer thickness on alumina ceramic substrates and then hardened in a box oven with gas circulation for 30 minutes at an object temperature of 150° C.

Table 1 shows proportions in vol.-% and wt.-% and test results for an example according to the invention (E4) as well as comparative examples (E1-E3, E5).

TABLE 1

| | | E1 | E2 | E3 | E4 | E5 |
|---|---|---|---|---|---|---|
| Components | AA-192N from Metalor | 10.9 vol.- | 0 vol.-%, | 7 vol.-%, | 13 vol.-%, | 0 vol.-%, |
| | (particles of (A) type) | %, 30 wt.-% | 0 wt.-% | 40 wt.-% | 40 wt.-% | 0 wt.-% |
| | FA-3162 from Metalor | 17.1 vol.- | 7 vol.-%, | 0 vol.-%, | 0 vol.-%, | 13 vol.-%, |
| | | %, 47 wt.-% | 40 wt.-% | 0 wt.-% | 0 wt.-% | 40 wt.-% |
| | AE9104 from | 0 vol.-%, | 0 vol.-%, | 0 vol.-%, | 31 vol.-%, | 31 vol.-%, |
| | Admatechs (particles of | 0 wt.-% | 0 wt.-% | 0 wt.-% | 40 wt.-% | 40 wt.-% |
| | (B) type) | | | | | |
| | (C) plus (D) | 72 vol.-%, | 93 vol.-%, | 93 vol.-%, | 56 vol.-%, | 56 vol.-%, |
| | | 23 wt.-% | 60 wt.-% | 60 wt.-% | 20 wt.-% | 20 wt.-% |
| Properties | Sheet resistivity | 1.34 | >1000 | >1000 | 0.84 | >1000 |
| | [mΩ · cm] | | | | | |
| | Density [g/cm³] | 3.2 | 1.7 | 1.7 | 2.7 | 2.9 |
| | Shear strength [MPa] | 15 | 12 | 8 | 8 | 10 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An electrically conductive composition comprising
(A) 2 to 35 vol.-% electrically conductive particles having an average particle size in the range of 1 to 25 μm and exhibiting an aspect ratio in the range of 5 to 30:1,
(B) 10 to 70 vol.-% non-metallic particles having an average particle size in the range of 1 to 25 μm and exhibiting an aspect ratio in the range of 1 to 3:1,
(C) 30 to 80 vol.-% of a curable resin system, and
(D) 0 to 10 vol.-% of at least one additive,
wherein the sum of the vol.-% of particles (A) and (B) totals 25 to 65 vol.-%.

2. The electrically conductive composition of claim 1, wherein the composition consists of 2 to 35 vol.-% of the electrically conductive particles (A), 10 to 70 vol.-% of the non-metallic particles (B), 30 to 80 vol.-% of the curable resin system (C) and 0 to 10 vol.-% of the least one additive (D).

3. The electrically conductive composition of claim 1, wherein the composition comprises 15 to 60 wt.-% of the electrically conductive particles (A), 10 to 75 wt.-% of the non-metallic particles (B), 7 to 35 wt.-% of the curable resin system (C), and 0 to 5 wt.-% of the at least one additive (D), wherein the sum of the wt.-% of particles (A) and (B) totals 60 to 93 wt.-%.

4. The electrically conductive composition of claim 3, wherein the composition consists of 15 to 60 wt.-% of the electrically conductive particles (A), 10 to 75 wt.-% of the non-metallic particles (B), 7 to 35 wt.-% of the curable resin system (C), and 0 to 5 wt.-% of the at least one additive (D).

5. The electrically conductive composition of claim 1, wherein the electrically conductive particles (A) are metal particles and/or metal alloy particles, and wherein the metal has an electrical conductivity of >10⁷ S/m.

6. The electrically conductive composition of claim 1, wherein the non-metallic particles (B) are graphite particles and/or electrically non-conductive non-metallic particles of a material having an electrical conductivity of <10⁻⁵ S/m.

7. The electrically conductive composition of claim 1, wherein the particles (A) have an average particle size in the range of 0.2 to 2 times the average particle size of the particles (B).

8. The electrically conductive composition of claim 1, wherein the curable resin system (C) comprises the constituents of the electrically conductive composition which, after the application and curing thereof, form a covalently crosslinked polymer matrix in which the (A) and (B) particles are embedded.

9. The electrically conductive composition of claim 1, wherein the curable resin system (C) comprises a self-crosslinkable epoxy resin or a system of an epoxy resin and a hardener for the epoxy resin selected from polyamine hardeners, polycarboxylic acid hardeners and polycarboxylic acid anhydride hardeners.

10. The electrically conductive composition of claim 9, wherein the curable resin system (C) comprises a system comprising an epoxy resin, polyamine hardener for the epoxy resin and optionally a lactone.

11. The electrically conductive composition of claim 1, wherein the composition has a viscosity in the range of 4 to 45 mPa·s, measured in accordance with DIN 53018 (at 23° C., CSR-measurement, cone-plate system, shear rate of 50 rounds per second).

12. A hardened electrically conductive composition obtained by hardening the electrically conductive composition of claim 1.

13. The hardened electrically conductive composition of claim 12, wherein the hardened composition is a solid with a specific weight in the range of 1.5 to 4 g/cm³.

14. The hardened electrically conductive composition of claim 12, wherein the composition exhibits a sheet resistivity of >0 to ≦5 mΩ·cm measured at 25° C.

15. An assembly comprising a substrate, an electronic component, and the electrically conductive composition of claim 1 between the substrate and the component.

16. The assembly of claim 15, wherein the electrically conductive composition is hardened.

17. A hardenable electrically conductive adhesive comprising the electrically conductive composition of claim 1.

18. The adhesive according to claim 17, wherein the adhesive is used in electronics or microelectronics applications.
